(19) United States
(12) Patent Application Publication
(10) Pub. No.: US 2023/0354824 A1
(43) Pub. Date: Nov. 9, 2023

(54) Minimum Risk Pesticide Formulations Containing Mineral Oil

(71) Applicant: Henkel AG & Co. KGaA, Düsseldorf (DE)

(72) Inventors: Daniel Thomas Piorkowski, Fairfield, CT (US); Anna Irene Peterson, Fairfield, CT (US)

(21) Appl. No.: 18/301,616

(22) Filed: Apr. 17, 2023

Related U.S. Application Data
(60) Provisional application No. 63/364,171, filed on May 4, 2022.

(51) Int. Cl. A01N 65/08; A01N 25/30; A01N 65/28; A01N 65/44; A01N 65/22; A01N 65/06; A01N 31/02; A01N 25/02; A01N 25/06

(52) U.S. Cl. CPC A01N 65/08; A01N 25/30; A01N 65/28; A01N 65/44; A01N 65/22; A01N 65/06; A01N 31/02; A01N 25/02; A01N 25/06

(57) ABSTRACT

An insecticidal composition includes one or more essential oils and/or vegetable oils having insecticidal properties, mineral oil in an amount of about 55 wt. % to about 95 wt. %, and isopropyl alcohol in an amount of about 10 wt. % or higher, wherein the insecticidal composition is substantially free of a lactate solvent, and wherein the insecticidal composition shows no phase separation at about 4° C. after about 72 hours of storage.

### FIELD OF THE INVENTION

This disclosure relates to mineral oil-based pesticide formulations. Specifically, the disclosure relates to mineral oil based minimum risk pesticide formulations containing isopropyl alcohol and beneficial combinations of solvents that achieve improved stability of the composition, and methods of using the same.

### BACKGROUND OF THE INVENTION

Insect pests, such as mosquitoes, flies, fleas, mites, and ticks, are known to be a nuisance to humans. Insect bites can cause discomfort or adverse inflammatory reactions. Some insects can carry bacterial and/or viral diseases that pose a significant health hazard to humans.

Accordingly, to kill, repel and/or control pests, insecticides or repellents are used in areas where the presence of these pests is not desired.

Synthetic chemical insecticides have historically provided effective means for controlling pests. However, there has been an increased concern that the widespread use of chemical insecticides has been detrimental to the environment and harmful to humans, animals, and beneficial insects. This is especially the case when chemical insecticides are used to treat larger areas, such as lawns or gardens. There has been increasing public concern that the amount of residual chemicals from synthetic insecticides that accumulate in the environment, including ground water and crops, can be toxic to humans, as well as domestic and wild animals and beneficial insects such as bees, butterflies, and other pollinators.

As a result, minimum risk pesticides are a growing sub-category in the insecticide marketplace. Essential oils are commonly used as the active material to kill a variety of pests, including ants, roaches, spiders, and flies. The essential oils are typically compounded with either mineral oil or water, along with other solvents. To kill insects, the consumer typically sprays the formula directly on the insect through a manual pump spray, aerosol, or garden hose attachment.

Raid Essentials (manufactured by SC Johnson) has a minimum risk pesticide product that utilizes essential oils, mineral oil, ethyl lactate, and isopropyl myristate. This product is not stable at any temperature (including room temperature) and phase separates within hours. This product is advised to shake before use.

Zevo (manufactured by P&G) has a minimum risk pesticide product that utilizes essential oils, mineral oil, butyl lactate, isopropyl myristate, isopropyl alcohol (IPA), and triethyl citrate (TEC). This product has good stability at temperatures above 4° C. At 4° C., phase separation can be observed and at −20° C. phase separation is observed.

These prior art formulations are not free of ethyl or butyl lactate and have stability issues.

There is a consumer need for mineral oil-based insecticide formulations that utilize environmentally safe and/or minimum risk active insecticide ingredients. It is also desirable to provide a liquid insecticide formulation that achieves improved efficacy, as well as improved stability at different temperatures.

It is, therefore, an object of the present invention to improve upon existing insecticide formulations containing essential oils.

It is also an object of the invention to provide an environmentally safe pesticide formulation containing minimum risk active insecticide ingredients.

It is further an object of the invention to provide a liquid pesticide formulation containing isopropyl alcohol and beneficial combinations of solvents to achieve improved benefits of efficacy and stability compared to the commercial products currently on the market and to eliminate isopropyl alcohol from separating from mineral oil under cold conditions (4° C. storage, such as the fridge).

### SUMMARY OF THE INVENTION

The foregoing is achieved by provision of an insecticide formulation including one or more essential oils and/or vegetable oils having insecticidal properties, mineral oil in an amount of about 55 wt. % to about 95 wt. %, and isopropyl alcohol in an amount of about 10 wt. % or higher. In some embodiments, the insecticidal composition is substantially free of a lactate solvent and shows no phase separation at about 4° C. after about 72 hours of storage.

In certain embodiments, the one or more essential oils and/or vegetable oils is selected from the group consisting of cottonseed oil, clove oil, lemongrass oil, peppermint oil, cedarwood oil, rosemary oil, and geraniol.

In some embodiments, the insecticidal composition is substantially free of water.

In some embodiments, the composition further includes at least one of the following: a preservative, a pH adjuster, a colorant, and a thickener.

The insecticidal composition may also include isopropyl myristate. When included, isopropyl myristate may be present in an amount of about 1 wt. % to about 10 wt. %.

In some embodiments, the insecticidal composition further includes one or more citric acid esters. The one or more citric acid esters may be triethyl citrate. In some embodiments, triethyl citrate is present in an amount of about 1 wt. % to about 5 wt. %.

In a second aspect of the invention, an insecticidal composition is provided including one or more essential oils and/or vegetable oils having insecticidal properties, and a solvent consisting essentially of a mineral oil, isopropyl alcohol and isopropyl myristate, wherein the insecticidal composition is stable at about 4° C. after about 72 hours of storage.

In some embodiments, the one or more essential oils and/or vegetable oils is selected from the group consisting of cottonseed oil, clove oil, lemongrass oil, peppermint oil, cedarwood oil, rosemary oil, and geraniol.

In some cases, the insecticidal composition may be substantially free of water.

The inventive composition may also include at least one of the following: a preservative, a pH adjuster, a colorant, and a thickener.

In some embodiments, the one or more essential oils and/or vegetable oils is present in an amount of about 0.1 wt. % to about 1 wt. %. In additional embodiments, the mineral oil is present in an amount of about 70 wt. % or more. In further embodiments, isopropyl alcohol is present in an amount of about 10 wt. % to about 20 wt. %. In yet further embodiments, isopropyl myristate is present in an amount of about 1 wt. % to about 10 wt. %.

In a third aspect of the invention, an insect control product is provided including the insecticidal composition described above and a propellant.

In yet another aspect, a method for controlling insects is provided, including the steps of providing an insecticidal composition having one or more essential oils and/or vegetable oils having insecticidal properties, mineral oil, and isopropyl alcohol, wherein the insecticidal composition is substantially free of a lactate solvent. The insecticidal composition is then diluted with water and the diluted insecticidal composition is applied to the target surface.

In some embodiments, the insecticidal composition is continuously diluted with water via a garden hose.

### DETAILED DESCRIPTION OF THE INVENTION

The following detailed description is merely exemplary in nature and is not intended to limit the disclosed pesticide formulations, or any associated methods for producing or using the same described herein. Furthermore, there is no intention to be bound by any theory presented in the preceding background or the following detailed description.

The term “about” as used in connection with a numerical value throughout the specification and the claims denotes an interval of accuracy, familiar and acceptable to a person skilled in the art. In general, such interval of accuracy is ±10%. Thus, “about ten” means 9 to 11. All numbers in this description indicating amounts, ratios of materials, physical properties of materials, and/or use are to be understood as modified by the word “about,” except as otherwise explicitly indicated.

“At least one”, as used herein, relates to one or more, i.e., 1, 2, 3, 4, 5, 6, 7, 8, 9, or more. If used in combination with a compound, the term does not relate to the absolute number of molecules but rather to the number of different types of said compound. “At least one essential oil” thus means that at least one type but that also two or more different essential oils can be present.

The term “substantially”, as used herein, means at least about 80%, preferably at least about 90%, more preferably at least about 99%, for example at least about 99.9%. In some embodiments, the term substantially can mean completely, or about 100%.

As used herein, the term “comprising” means including, made up of, composed, characterized by or having.

“Free of”, as used herein in relation to a specific type of component, means that the referenced composition does not contain more than 0.5 wt. %, preferably no more than 0.1 wt. %, more preferably no more than 0.05 wt. % of said component relative to the total weight of the composition. Most preferably, said component is not contained at all.

As used in this specification and the associated claims, organic molecules may be represented using the notation of the letter C followed by a number, e.g., C12. The number indicates the number of carbon atoms in the associated organic molecule. The identified organic molecules need not be hydrocarbons but may include substitutions, for example, C3 polyols would include both glycerin and propylene glycol, both of which have three carbons in their structure and multiple hydroxyl substitutions.

The term “arthropod” refers to invertebrate animals with jointed limbs, a segmented body, and an exoskeleton. They belong to the phylum Arthropoda and include, but are not limited to insects, mites, spiders, ticks, arachnoids, arachnids, larvae, parasites, and like invertebrates.

The compositions and methods of the invention may be used to kill any type of arthropod, such as an insect. Exemplary arthropods that can be killed include but are not limited to beetles, cockroaches, flies, ants, larvae, lice, fleas, mosquitoes, mites, ticks, and the like. Exemplary arthropod orders can include but are not limited to orders Acariformes, Anoplura, Araneae, Blattodea, Coleoptera, Collembola, Diptera, Grylloptera, Hemiptera, Heteroptera, Homoptera, Isopoda, Isoptera, Ixodida, Mantodea, Mallophaga, Neuroptera, Odonata, Orthoptera, Parasitiformes, Psocoptera, Siphonaptera, Symphyla, Thysanura, and Thysanoptera, and the like.

The terms “insecticide formulation,” “insecticide composition”, “pesticide formulation,” and “pesticide composition” as used herein refers to a composition that causes at least about 1% of the exposed arthropods to die. In some embodiments, the terms encompass compositions that cause at least about 5%, at least about 10%, at least about 25%, at least about 50%, at least about 75% and at least about 90% of the exposed arthropods to die.

Absent explicit statement to the contrary, reference to wt. %, or wt %, or percent by weight, in the specification refers to the weight percentage of an ingredient as compared to the total weight of the insecticide composition. The wt. % of the total water in the liquid composition is calculated based on all the water including those added as a part of individual ingredients. When an ingredient added to make the liquid composition is not 100% pure and used as a mixture, e.g., in a form of a solution, the wt. % of that material added refers to the weight percentage of the mixture. Thus, a component which is 5 wt. % of the formulation, may be added as 5 wt. % of a pure component or 10 wt. % of solution that is 50% component and 50% water. Either result produces the recited 5 wt. % amount of the component in the resulting formulation. All percentages presented in this specification and the associated claims are weight percentages unless explicitly identified otherwise. If not indicated otherwise, all percentages refer to active matter and are by weight relative to the total weight of the composition.

The term “carrier” as used herein refers to an inert or fluid material, which may be inorganic or organic and of synthetic or natural origin, with which the active compound is mixed or formulated to facilitate its application to the object to be treated, or its storage, transport and/or handling.

The pesticide compositions of the present invention can be provided in the form of an oil-in-water emulsion, a water-in-oil emulsion, a micelle formulation, a solution, a suspension, a dispersion, and the like.

### Oils

The pesticide compositions of the invention utilize one or more essential oils or vegetable oils as active pesticide ingredients. Suitable oils include, but are not limited to, those listed as Active Ingredients Eligible for Minimum Risk Pesticide Products by the United States Environmental Protection Agency (40 C.F.R. 152.25(f)(1)). The essential and vegetable oils usable here may include, but are not limited to, castor oil, cedarwood oil, cinnamon oil, citronella oil, clove oil, corn oil, cornmint oil, cottonseed oil, eugenol, garlic oil, geraniol, geranium oil, lemongrass oil, linseed oil, peppermint oil, rosemary oil, sesame oil, soybean oil, spearmint oil, thyme oil, and combinations thereof. Additional oils that may be used with the inventive pesticide compositions include, but are not limited to, betula oil, thymol, black seed oil, linalool, vanillin, isopropyl myristate, piperonal, pinenes, cymene, lilac flower oil, lime oil, cumin oil, mineral oil, olive oil, peanut oil, safflower oil, and combinations thereof. In some preferred embodiments, cottonseed oil, clove oil, lemongrass oil, peppermint oil, rosemary oil, cedarwood oil, geraniol or mixtures thereof are used.

In addition to the essential and vegetable oils, the inventive compositions may utilise one or more other active ingredients listed as Active Ingredients Eligible for Minimum Risk Pesticide Products by the EPA (40 C.F.R. 152.25(f)(1)). Such ingredients include, but are not limited to, citric acid, corn gluten meal, dried blood, lauryl sulfate, malic acid, 2-phenylethyl propionate, potassium sorbate, putrescent whole egg solids, sodium chloride, sodium lauryl sulfate, white pepper, zinc, and combinations thereof.

The essential and vegetable oils may be prepared from one or more plant parts, including but not limited to leaves, stems, bark, flowers, roots, seeds, and/or fruits. Additionally, the inventive compositions may optionally comprise one or more active components isolated from one or more essential oils.

The essential oils may also have a secondary benefit of providing an olfaction effect to the pesticidal compositions, in addition to a pesticidal effect. In some embodiments, one or more essential oils described above are included in the inventive compositions to function as fragrances. Representative essential oils include floral or plant oil fragrances such as citrus, clove, eucalyptus, wintergreen, rosemary, citronella, or cinnamon oil, which also possesses pesticidal and antimicrobial properties. In some embodiments, the essential oils can also impart a beneficial property to the compositions, for example, where menthol is used as both a fragrance and an anti-itch component when the compositions are applied to human or animal skin. In preferred embodiments, the pesticide compositions are essentially free from any active ingredients not listed as Active Ingredients Eligible for Minimum Risk Pesticide Products by the EPA (40 C.F.R. 152.25(f)(1)).

The composition of the invention may also utilize one or more vegetable oils. Examples of a vegetable oil that may be used include, but are not limited to, soybean oil, safflower oil, olive oil, linseed oil, cottonseed oil, corn oil, coconut oil, cod liver oil, castor oil, hydrogenated castor oil, peanut oil, sperm oil, cocoa, palm-oil, wheat germ oil, sweet almond oil, sesame oil, hydrogenated soybean oil, soy lecithin, white mineral oil, hydrogenated cottonseed oil, hydrogenated palm-oils, rice bran oil, wheat oils, wintergreen oil, hydrogenated rapeseed oil, canola oil, hydrogenated castor oil, and any combinations thereof.

The oils may be used alone or in a combination of two or more oils. In the compositions including two or more oils, each oil can make up between about 0.1% to about 99%, by weight or volume, of the oil combination or mixture. In some embodiments, two oils are used in about 1:5 to about 5:1 ratio. In additional embodiments, the oils are used in about 1:3 to about 3:1 ratio. In some embodiments, two oils are used in about 1:2 to about 2:1 ratio. In some preferred embodiments, two oils are used in about 1:1 ratio.

In some embodiments, the insecticide composition comprises a mixture of three oils. In those embodiments, each of the oils may be present in an amount within a range of about 10% to about 90% of the oil mixture. In additional embodiment, each of the oils may be present in an amount within a range of about 20% to about 80% of the oil mixture, or within about 30% to about 70% of the oil mixture. In some preferable embodiments, each of the oils in the mixture is present in an amount within a range of about 30% to about 35% of the oil mixture.

Typically, the insecticide composition contains about 0.01 wt. % to about 25% total by weight of the composition of one or more essential or vegetable oils, preferably about 0.05 wt. % to about 15 wt. % of essential or vegetable oils, preferably about 0.1 wt. % to about 5 wt. % of essential or vegetable oils, more preferably about 0.5 wt. % to about 5 wt. % of essential or vegetable oils.

In some embodiments, the essential oils may also act as passive or inert composition ingredient, including, but not limited to, as a carrier, a diluent or a dispersant to assist in distributing or spreading the active insecticide ingredient(s).

### Mineral Oil

The pesticide formulations of the present invention may be water-based, oil-based formulations or combinations of those formulations. In some embodiments, the inventive pesticide compositions are oil-based compositions that are essentially free of water. In these embodiments, the pesticide compositions typically include a mineral oil component that functions as a solvent/diluent and/or carrier. Such mineral oil-based pesticide compositions may be preferable because they are more efficacious on larger arthropods (like small or large roaches), in addition to smaller arthropods, such as ticks, fleas, and flies.

Mineral oil may function as a carrier oil to provide residual killing power on surfaces for up to, as much as, four weeks or more. The essential oil is dissolved in the carrier oil and prevents the rather volatile essential oil from evaporating quickly. As a result, the insects come in contact with the carrier oil composition that will eventually kill them.

Many other oils other than mineral oil are capable of performing the function of the carrier oil and may also be used with the inventive pesticide compositions. Examples of such oils includes, but are not limited to, soybean oil, canola oil, corn oil, sunflower oil, neem oil, peanut oil, sesame oil, cottonseed oil, fish oil, olive oil, safflower oil, or castor oil. In some embodiments, Wintergreen oil and Wheat Germ Oil can be used in place of mineral oil.

The inventive pesticide composition may utilize any suitable mineral oils. In a preferred embodiment, the pesticide compositions utilize a mineral oil that is paraffinic and has a kinetic viscosity of about 10 to 20 cSt at 40° C. (ASTM D445), as well as a Saybolt Universal Viscosity of about 70 at 100° F. (ASTM D2161). PURETOL™ 7 from Petro-Canada is an exemplary oil that fits this definition. PURETOL™ 7 is an odorless and colorless white mineral oil with a Saybolt viscosity of 70 and a specific gravity of 0.853.

A food-grade mineral oil is not required but is preferred for the pesticide compositions of the present invention.

In some embodiments, mineral oil is present in an amount of from about 1 to about 95 weight percent, or from about 10 to about 90 weight percent by weight of the pesticide composition. Preferably, mineral oil is present in an amount of about 60 percent to about 90 percent by weight of the pesticide composition and more preferably in about 70 percent by weight to about 85 percent by weight of the pesticide composition.

In some embodiments, the inventive pesticide compositions are water-based formulations that are essentially free of mineral oil. Water-based formulations may be advantageous when they are applied to a large surface area by being diluted with additional water, such as when applied via a conventional garden hose. Water-based formulations may also have the advantage of not leaving behind an oily residue, which may be desirable for certain treatment surfaces, such as plants, outdoor deck and furniture, etc.

Water is used as a solvent and carrier to disperse the pesticide formulation over the treatment area.

### Solvents

The inventive pesticide composition may include various solvents.

In the water-based composition, a solvent serves to reduce the water-oil surface tension of the emulsion or composition. By reducing the surface tension, the oil spots containing pesticidal essential oil components are more readily dispersed in the water, and a thin film of the oil-water mixture is formed on the treated surfaces. The solvent may also serve as a carrier and a synergist. The solvent may assist in fast penetration through the cell membrane of an arthropod being controlled to ensure the arrival of sufficient active ingredients to the site of action. The solvent may assist in wetting the arthropod exoskeleton to facilitate exposure of the cell membrane to the formulation and/or may dissolve portions of the exoskeleton.

Various solvents may be used in accordance with the present invention, either alone or in combination of two or more solvents. One suitable solvent is mineral oil, as discussed above. Additional suitable solvents include, but are not limited to, lower alcohols or esters having a molecular weight of less than 400.

In some embodiments, the inventive pesticide compositions include citric acid esters and/or lactic acid esters, including but not limited to triethyl citrate, ethyl lactate and butyl lactate and mixtures thereof. These solvents may be present in an amount of about 0.01 wt. % to about 25 wt. %, or about 1 wt. % to about 15 wt. %, or about 1 wt. % to about 5 wt. % by weight of the inventive pesticide composition. In some preferred embodiments, triethyl citrate, ethyl lactate and butyl lactate solvents, or a mixture thereof, are present in an amount of about 2 wt. % to about 3 wt. %.

In certain embodiments of the oil-based pesticidal composition, isopropyl alcohol as used as a co-solvent, as discussed in more detail below.

In additional embodiments, the pesticidal composition further includes isopropyl myristate as an additional solvent. Isopropyl myristate may be present in an amount of about 0.1 wt. % to about 20 wt. %, or 1 wt. % to about 8 wt. %, or about 2 wt. % to about 6 wt. %.

The present inventors have discovered unexpectedly that a formulation containing only essential oils, mineral oil, and isopropyl myristate was able to provide good phase stability at 4° C. and above, as discussed in more detail below.

It was also discovered that ethyl lactate has poor phase stability when used around 5-10% of the formulation. Furthermore, the inventors surprisingly discovered that removal of lactate from a mineral-oil based formulation containing isopropyl alcohol (IPA) added in the stability of IPA.

### Isopropyl Alcohol

The inventors have found that the use of isopropyl alcohol—2-propanol—in a liquid pesticide composition, in particular, in a mineral-oil based pesticide composition, has a positive effect on volatilization of essential oils. After the pesticide formulation is applied, e.g., by direct spraying of a pest or application to a larger area containing pests, isopropyl alcohol volatizes and facilitates volatilization of active insecticide essential oils to achieve distribution over a larger area of control. It has been found that the inventive pesticide compositions containing isopropyl alcohol achieve better volatilization than pesticide compositions without isopropyl alcohol, such as e.g., containing only water and/or mineral oil as carriers. Prior to the invention, it was neither known nor obvious that certain small levels of isopropyl alcohol would improve the volatilization of the essential oils.

It is understood that the inventive pesticide compositions may also be prepared without the use of isopropyl alcohol.

Isopropyl alcohol suitable for the inventive formulations may be of different purity grades. In one embodiment, 70% pure isopropyl alcohol is used. In a more preferred embodiment, the insecticide formulation contains 99% pure isopropyl alcohol.

In some embodiments, isopropyl alcohol is present in an amount of from about 0 to about 25 wt. %, from about 1 to about 20 wt. %, or from about 5 to about 15 wt. %.

### Surface Active Agents

The inventive compositions may further utilize surface active agents. Surface active agents function as emulsifying and dispersing agents to distribute the active essential oil ingredients in the water-based or an oil-in-water emulsion composition. The particular type of dispersing and emulsifying agents and the amount employed may be chosen based on the nature of the composition and the ability of the agent to facilitate the dispersion of the pesticidal compositions of the present invention.

The emulsifier may be any suitable compound or mixture of compounds. Embodiments of suitable emulsifiers include one or more cationic emulsifiers, anionic emulsifiers, and non-ionic emulsifiers, and mixtures thereof. For example, suitable emulsifiers may include, but are not limited to, fatty acids, esterified fatty acids, soaps, lecithin, polyethylene oxide esters of fatty acids, polyethylene oxide ethers of fatty alcohols, cyclodextrins, alkyl sulfates, alkyl sulfonates, aryl sulfonates, the condensation products of alkylene oxides with phenol and organic acids, complex ether alcohols, quaternary ammonium compounds, and the like.

In one embodiment, one or more fatty acids are used as surface active agent in the inventive pesticide composition. As used herein, the term “fatty acids” refers to alkyl chains having a carboxylic acid substituent at one end of the alkyl chain and a methyl (CH₃) substituent at the other end of the alkyl chain. Such fatty acids may be saturated or unsaturated. The term “long chain fatty acids” as used herein refers to alkyl chains having 14 to 24 carbon atoms. Fatty acids of fewer than fourteen carbon atoms are referred to herein by their carboxylic acid name, such as hexanoic acid, heptanoic acid, octanoic acid, nonanoic acid, decanoic acid, undecanoic acid, dodecanoic acid, etc.

In one embodiment, the fatty acid includes a fatty acid selected from among soy, soybean, coconut, castor, rapeseed, canola, silicone, and paraffin fatty acids. In one preferred embodiment, a coconut fatty acid is used. In additional embodiments, polyglycerol oleate is used in the compositions of the present invention.

In additional embodiments, one or more alkyl sulfates are used. In one example, Sodium Lauryl Sulfate (SLS) may be used to disperse/emulsify a water-based or an oil-in-water emulsion composition.

In one embodiment, the amount of emulsifiers/dispersing agents (or other suitable surface-active agents) in the composition is preferably in the range from about 0.01 wt. % to 50 wt. %, or from about 0.1 wt. % to about 30 wt. %, or from about 1 wt. % to about 20 wt. % by weight of the pesticide composition. In some preferred embodiments, emulsifiers/dispersing agents are present in an amount of about 1 wt. % to about 10 wt. %, and more preferably about 1 wt. % to about 5 wt. % by weight of the composition.

### Other Ingredients

Embodiments of the present invention can various other ingredients known in the art to be typically used in such formulations. These ingredients can include, but are not limited to, fillers, dispersants, water or other solvent medium or media, surfactants, suspension agents, sticking agents, stabilizers, preservatives, dyes, pigments, masking agents, emollients, excipients, post-application detection agents, additional active ingredients, antifoaming agents, anti-microbial agents, anti-oxidants, emulsifiers, fats, fluorescent materials, fungicides, hydrotropes, optical brighteners, perfume carriers, perfume, proteins, silicones, solubilizers, sugar derivatives, waxes, and the like.

The compositions of the present invention may also include additional active ingredients such as, for example, additional pest-combating ingredients, such as repellents and/or cidal agents. By way of example, the compositions may be formulated with an insect repellent ingredient. The repellents/cidal agents are preferably, but not necessarily, naturally occurring agents.

### Surfactants

Surfactants are well known in the art, and any combination of suitable surfactants or surfactant systems can be used in the pesticidal compositions described herein. Surfactants may function to modify the properties of the carrier to increase the dispersion and/or suspension of the active pesticide agents in an aqueous solution (i.e., stabilize an oil-in-water emulsion when the pesticide composition is diluted with water). Further, by modifying the carrier to increase dispersion and/or suspension of the active pesticide agents in aqueous solution, the pesticide agents will be able to be effectively delivered (e.g., via a sprayer) without the active sticking/adhering to the inner walls of the delivery device or clogging delivery components (e.g., sprayer nozzle, sprayer tubing, etc.).

The compositions of the invention may contain one or more surfactants. Useful surfactants in the pesticidal compositions of the present invention include, for example, an anionic surfactant, a nonionic surfactant, a cationic surfactant, an ampholytic surfactant, a zwitterionic surfactant, and/or mixtures thereof. The use of multiple surfactants of a particular type or a distribution of different weights of a surfactant may be particularly useful.

Suitable anionic surfactants are alkali metal, alkaline earth metal or ammonium salts of sulfonates, sulfates, phosphates or carboxylates. Examples of sulfonates are alkylarylsulfonates, diphenylsulfonates, alpha-olefinsulfonates, sulfonates of fatty acids and oils, sulfonates of ethoxylated alkylphenols, sulfonates of condensed naphthalenes, sulfonates of dodecyl-and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates and carboxylated alcohol or alkylphenol ethoxylates.

Suitable nonionic surfactants are alkoxylates, N-alkylated fatty acid amides, amine oxides, esters or sugar-based surfactants. Examples of alkoxylates are compounds such as alcohols, alkylphenols, amines, amides, arylphenols, fatty acids or fatty acid esters which have been alkoxylated. Ethylene oxide and/or propylene oxide may be employed for the alkoxylation, preferably ethylene oxide. Examples of N-alkylated fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides.

Suitable cationic surfactants are quaternary surfactants, for example quaternary ammonium compounds with one or two hydrophobic groups, or salts of long-chain primary amines. Suitable amphoteric surfactants are alkylbetaines and imidazolines. Suitable block polymers are block polymers of the A-B or A-B-A type comprising blocks of polyethylene oxide and polypropylene oxide or of the A-B-C type comprising alkanol, polyethylene oxide and polypropylene oxide. Suitable polyelectrolytes are polyacids or polybases. Examples of polyacids are alkali metal salts of polyacrylic acid. Examples of polybases are polyvinylamines or polyethyleneamines.

The composition according to the invention can comprise various amounts of surfactants. It can comprise from 0.1 to 40% by weight, preferably from 1 to 30% by weight, more preferably from 2 to 20% by weight, and in particular from 2 to 10% by weight of total amount of surfactants, based on the total amount of the composition.

### pH Adjusting Agents

pH adjusting agents may be added to and included in the pesticide compositions. Exemplary pH adjusting agents include monoethanol amine, binary amines, buffers, triethanol amine, metal hydroxides, or other materials. Exemplary metal hydroxides are sodium hydroxide and/or potassium hydroxide, and other possible pH adjusting agents include compounds that adjust the pH of the composition, such as citric acid.

pH adjusting agents may be present in the pesticide composition at an amount of from about 0 to about 10 weight percent in some embodiments, based on the total weight of the composition, but in other embodiments the pH adjusting agent may be present in the wash composition at an amount of from about 0.5 to about 5 weight percent, or an amount of from about 0.5 to about 3 weight percent, based on the total weight of the composition. In preferred embodiments, the pH adjusting agents are present in an amount of about 0 to about 0.5 weight percent, based on the total weight of the composition.

The pH adjusting agent may be utilized to adjust the pH of the pesticide composition to from about 2 to about 8, or from about 3 to about 6.5 in various embodiments.

The pH adjusting agent may form a cation that combines with an anionic surfactant and/or a coconut fatty acid and/or another anionic component within the composition. In many cases, the pH adjusting agent forms a salt with an anionic component. As such, the anionic surfactant may be present in the composition as a surfactant salt, and the coconut fatty acid may be present in the composition as a coconut fatty acid salt. In some embodiments, the pH adjusting agent is included in a slight excess relative to the anionic surfactant or other acidic components to adjust the pH of the composition to within a desired range, such as the range(s) mentioned above. As used herein, the terms “anionic surfactant” and “coconut fatty acid” include the neutralization products thereof.

### Humectants

A humectant, for purposes of the present invention, is a substance that exhibits high affinity for water, especially attracting water for moisturization and solubilization purposes. The water is absorbed into the humectant; not merely adsorbed at a surface layer. The water absorbed by the humectant is available to the system; the water is not too tightly bound to the humectant. Humectants possess hydrophilic groups which form hydrogen bonds with water. Common hydrophilic groups include hydroxyl, carboxyl, ester, and amine functionalities. A humectant can thus act as a solubilizer and moisture regulator in a composition.

Useful humectants include but not limited to polyols. The polyol (or polyhydric alcohol) may be a linear or branched alcohol with two or more hydroxyl groups. Thus, diols with two hydroxyl groups attached to separate carbon atoms in an aliphatic chain may also be used. The polyol typically includes less than 9 carbon atoms, such as 9, 8, 7, 6, 5, 4, 3, or 2 carbon atoms. Preferably, the polyol includes 3 to 8 carbon atoms. More preferably, the polyol includes 3 to 6 carbon atoms. The molecular weight is typically less than 500 g/mol, such as less than 400 g/mol or less than 300 g/mol.

Embodiments of suitable polyols include, but not limited to: propylene glycol, butylene glycol, pentylene glycol, hexylene glycol, heptylene glycol, octylene glycol, 2-methyl-1,3-propanediol, xylitol, sorbitol, mannitol, diethylene glycol, triethylene glycol, glycerol, erythritol, dulcitol, inositol, and adonitol.

The pesticide compositions of the present invention may contain about 5 wt. % to about 75 wt. % of one or more humectants, or about 7 wt. % to about 50 wt. %, or about 10 wt. % to about 40 wt. %, or about 20 to 30 wt. % of one or more C2 to C5 polyols.

### Preservatives

In order to provide a reasonable shelf-life to the inventive pesticidal compositions, it is preferable that a preservative be added to the composition. Any suitable commercially available preservatives may be used with the inventive compositions.

One such suitable preservative is sodium benzoate commercially available preservatives used for preserving food, as would be known to those of ordinary skill in the art, may also be suitably used. Examples of suitable preservatives include, but are not limited to, formaldehyde, alkyl esters of p-hydroxybenzoic acid, sodium benzoate, potassium sorbate, 2-bromo-2-nitropropan-1,3-diol, o-phenyiphenol, thiazolinones such as benzisothiazolinone, 5-chloro-2-methyl-4-30 isothiazolinone, pentachlorophenol, 2,4-dichlorobenzyl alcohol, citric acid, and mixtures thereof. In one preferred embodiment, the pesticidal composition includes potassium sorbate as a preservative. In another embodiment, the composition of the invention may also include citric acid as a preservative.

The pesticide compositions of the present invention may contain about 0.001 wt. % to about 5 wt. % of one or more preservatives, or about 0.01 wt. % to about 2 wt. %, or about 0.1 wt. % to about 0.3 wt. % of one or more preservatives.

### Colorants

Further, the pesticide compositions of the present invention may additionally contain a coloring agent or colorant. In some embodiments, the pesticide composition contains one or more colorants. Suitable examples of such coloring agents or colorants that may be utilized include, but are not limited to, inorganic pigments such as metal oxides, titanium oxides and Prussian blue, organic dyes such as alizarine dyes, azodyes and metallic phthalocyanine dyes, iron, manganese, boron, copper, cobalt, molybdenum, zinc and salts thereof, and the like, or a mixture thereof.

The colorant(s) can be, for example, polymers. The colorant(s) can be, for example, dyes. The colorant(s) can be, for example, water-soluble polymeric colorants. The colorant(s) can be, for example, water-soluble dyes. The colorant(s) can be, for example, colorants that are well-known in the art or commercially available from dye or chemical manufacturers. The color of the colorant(s) is not limited, and can be, for example, red, orange, yellow, blue, indigo, violet, or any combination thereof.

The total amount of the one or more colorant(s) that can be contained in the pesticidal composition, for example, can range from about 0.00001 wt. % to about 0.099 wt. %. The total amount of colorant(s) in the pesticidal composition can be, for example, about 0.0001 wt. %, about 0.001 wt. %, about 0.01 wt. %, about 0.05 wt. %, or about 0.08 wt. %.

### Bittering Agents

Bittering agents may optionally be added to hinder accidental ingestion of the pesticidal composition. Bittering agents are compositions that taste bad, so children or others are discouraged from accidental ingestion. Exemplary bittering agents include denatonium benzoate, aloin, and others. Bittering agents may be present in the wash composition at an amount of from about 0 to about 1 weight percent, or an amount of from about 0.001 to about 0.5 weight percent, or an amount of from about 0.001 to about 0.25 weight percent in various embodiments, based on the total weight of the pesticidal composition.

### Methods of Use

The compositions of the present invention may be used to eliminate arthropods either by direct application to a host, such as human, animal or plant, or by treatment of an area within which a host is located.

In some embodiments, the pesticidal compositions are distributed over a larger area, such as lawn or garden, to kill targets located therein. In these embodiments, the pesticidal composition may be provided in a concentrated form to be further diluted with additional water. In one embodiment, the pesticide composition is diluted with water at a ratio of about 0.01 to about 5 parts of the pesticide composition to about 95 to 99.99 parts of water. In further embodiments, the pesticide composition is diluted with water to a ratio of about 5 parts of the composition to about 95 parts of water, or about 4 parts of the composition to about 94 parts of water, or about 3 parts of the composition to about 97 parts of water. Preferably, the dilution is such that one litre or 33 fluid ounces of the diluted composition is suitable to be applied to about 2,000 square feet to about 15,000 square feet of target surface. The diluted composition is then sprayed over the target area by any suitable method.

The pesticidal composition may be diluted with water by attaching a container containing the composition to a garden hose or any other water supplying device. Water is then passed from the hose through the container to continuously dilute the pesticidal composition in the container with additional water. The diluted composition is then sprayed from the container under the pressure of the water hose to the target area.

Once the pesticidal composition of the present invention is applied to a target area, it is effective at killing a certain percentage of arthropods within a certain time period. In some embodiments, at least 75% of arthropods are killed within 24 hours from exposure. In additional embodiments, at least 90% of arthropods are killed within 24 hours from exposure. In further embodiments, at least 50% of arthropods are killed within 30 seconds of exposure and at least 90% of arthropods are killed within 30 minutes of exposure. In other embodiments, at least 25% of arthropods are killed within 30 minutes of exposure, and at least 35% of arthropods are killed within 1 hour of exposure, and at least 40% of arthropods are killed within 1 hour from exposure.

In other embodiments, the pesticidal composition may be provided in a form of a pressurized aerosol or a trigger spray. The aerosol/spray is used to spray a host (human, animal, etc.) or a target area where arthropods may be located. Mixtures of liquefied hydrocarbons, such as propellants A-46, A-70, or 142A, may be used as propellants in embodiments of spray mixtures. Additional propellants may include butane gas, propane gas, liquid petroleum gas, dimethyl ether, carbon dioxide, and the like, and a mixture thereof.

### EXAMPLES

All compositions described below are given in % weight of each material included in the formula.

### Example 1

The following batches were made using a standard over-head mixer (Caframo Stirrer BDC3030), with the rpm set between 200-400 to provide sufficient agitation. Order of addition was mineral oil, isopropyl alcohol, isopropyl myristate, butyl lactate, triethyl citrate, and then the essential oils.

All formulas showed good stability (no phase separation or discoloring) at 25° C., 45° C., 54° C. However, the formulas had some phase separation at both 4° C. and −20° C. when stored in glass or PET bottles. All formulas were water white and transparent.

All formulas listed in Table 1 had a viscosity of approximately 5 to 30 centipoise (cP) at 25° C.

TABLE 1

| | For- | For- | For- | For- | For- | For- |
|---|---|---|---|---|---|---|
| | mula | mula | mula | mula | mula | mula |
| Component | 1 | 2 | 3 | 4 | 5 | 6 |
| White Mineral Oil | 80 | 80 | 80 | 80 | 80 | 80 |
| Isopropyl Alcohol | 15 | 15 | 15 | 15 | 15 | 15 |
| Isopropyl | 1.5 | 1.5 | 1.5 | 1.5 | 1.5 | 1.5 |
| Myristate | | | | | | |
| n-Butyl Lactate | 1.5 | 1.5 | 1.5 | 1.5 | 1.5 | 1.5 |
| Triethyl Citrate | 1.5 | 1.5 | 1.5 | 1.5 | 1.5 | 1.5 |
| Cottonseed Oil | | 0.05 | 0.25 | 0.17 | 0.17 | 0.13 |
| Clove Oil | | 0.05 | 0.25 | 0.17 | 0.17 | 0.13 |
| Lemongrass Oil | | | | | 0.17 | |
| Peppermint Oil | | | | | | 0.13 |
| Rosemary Oil | | | | | | 0.13 |
| Geraniol | | | | 0.17 | | |
| TOTAL | 99.5 | 99.6 | 100 | 100.00 | 100 | 100 |

### Example 2

The following batches were made using a standard over-head mixer (Caframo Stirrer BDC3030), with the rpm set between 200-400 to provide sufficient agitation. Order of addition was mineral oil, isopropyl alcohol, isopropyl myristate, butyl lactate, triethyl citrate, then the essential oils.

All formulas listed in Table 2 showed good stability (no phase separation or discoloring) at 25° C., 45° C., 54° C.; but had some phase separation at both 4° C. and −20° C. when stored in glass or PET bottles.

TABLE 2

| | For- | For- | For- | For- | For- |
|---|---|---|---|---|---|
| Component | mula 7 | mula 8 | mula 9 | mula 10 | mula 11 |
| White Mineral Oil | 77.75 | 77.75 | 77.75 | 77.75 | 77.75 |
| Isopropyl Alcohol | 17.5 | 17.5 | 17.5 | 17.5 | 17.5 |
| Isopropyl Myristate | 2.88 | 2.88 | 2.88 | 2.88 | 2.88 |
| n-Butyl Lactate | 1 | 1 | 1 | 1 | 1 |
| Triethyl Citrate | 0.38 | 0.38 | 0.38 | 0.38 | 0.38 |
| Cottonseed Oil | | 0.17 | 0.14 | 0.13 | 0.13 |
| Clove Oil | | 0.17 | 0.13 | | |
| Lemongrass Oil | | 0.17 | | | 0.13 |
| Peppermint Oil | | | 0.09 | 0.13 | 0.13 |
| Rosemary Oil | | | 0.14 | 0.13 | 0.13 |
| Cedarwood Oil | | | | 0.13 | |
| Total | 99.5 | 100.00 | 100.00 | 100.00 | 100.00 |

Thus, it was observed that at 4° C., formulas containing both mineral oil and IPA (Formulas 1-11) have poor stability and higher phase separation. This can occur within hours or overnight. This can be problematic since product may be exposed to low temperatures during shipping or even in the consumer's home (storage in a shed, garage or car). To re-mix the formula, the formula needs to have the temperature increased along with sufficient agitation. Without sufficient agitation, the consumer may not have a homogeneous product when using it and can cause potential staining damage due to higher amounts of IPA being sprayed when the bottle is nearly empty.

### Example 3

The following batches were made using a standard over-head mixer (Caframo Stirrer BDC3030), with the rpm set between 200-400 to provide sufficient agitation. Order of addition was mineral oil, isopropyl alcohol, isopropyl myristate, triethyl citrate, then the essential oils.

All formulas listed in Tables 3 and 4 showed good stability at −20° C., 25° C., 45° C., and 54° C. It was observed by the inventors that stability of the pesticidal compositions is dependent on the amount of isopropyl alcohol in the formulation. Formulas 18-20 (5 wt. % IPA) and Formulas 21-23 (1 wt. % IPA) had less than 10 wt. % isopropyl alcohol and were stable at low temperatures even with lactate and citrate solvents present in the formulation. Instability of the pesticidal compositions with 10 wt. % or more of isopropyl alcohol is believed to be caused at least in part by the IPA separating out of the formulation.

TABLE 3

| | Aerosol-Type: High IPA, Low TEC | | |
|---|---|---|---|
| Component | Formula 18 | Formula 19 | Formula 20 |
| White Mineral Oil | 80.00 | 80.00 | 80.00 |
| Isopropyl Alcohol | 5 | 5 | 5 |
| Isopropyl Myristate | 7.97 | 7.97 | 7.97 |
| Triethyl Citrate | 1.5 | 1.5 | 1.5 |
| Cottonseed Oil | | 0.33 | 0.25 |
| Clove Oil | | 0.33 | 0.25 |
| Lemongrass Oil | | 0.33 | |
| Peppermint Oil | | | 0.25 |
| Rosemary Oil | | | 0.25 |
| TOTAL | 94.47 | 95.47 | 95.47 |

TABLE 4

| | Aerosol-Type; Low IPA, Low TEC | | |
|---|---|---|---|
| Component | Formula 21 | Formula 22 | Formula 23 |
| White Mineral Oil | 80.00 | 80.00 | 80.00 |
| Isopropyl Alcohol | 1 | 1 | 1 |
| Isopropyl Myristate | 7.41 | 7.41 | 7.41 |
| n-Butyl Lactate | 4.53 | 4.53 | 4.53 |
| Triethyl Citrate | 1.54 | 1.54 | 1.54 |
| Cottonseed Oil | | 0.333 | 0.25 |
| Clove Oil | | 0.334 | 0.25 |
| Lemongrass Oil | | 0.333 | |
| Peppermint Oil | | | 0.25 |
| Rosemary Oil | | | 0.25 |
| TOTAL | 94.48 | 95.48 | 95.48 |

### Example 4

The following batches were made using a standard over-head mixer (Caframo Stirrer BDC3030), with the rpm set between 200-400 to provide sufficient agitation. Order of addition was mineral oil, ethyl lactate, isopropyl myristate, then the essential oils.

Formula 24 listed in Table 5 did not show good stability and had phase separation immediately.

Formula 28-30 listed in Table 6 showed good stability at −20° C., 4° C., 25° C., 45° C., 54° C. in PET bottles.

TABLE 5

| | Ethyl Lactate Base |
|---|---|
| Component | Formula 24 |
| White Mineral Oil | 80.00 |
| Ethyl Lactate | 9.2 |
| Isopropyl Myristate | 9.2 |
| TOTAL | 98.4 |

TABLE 6

| | Low Butyl Lactate Base | | |
|---|---|---|---|
| Component | Formula 28 | Formula 29 | Formula 30 |
| White Mineral Oil | 78.00 | 78.00 | 78.00 |
| Isopropyl Myristate | 16.75 | 16.75 | 16.75 |
| n-Butyl Lactate | 4.75 | 4.75 | 4.75 |
| Cottonseed Oil | | 0.125 | 0.16 |
| Clove Oil | | 0.125 | 0.17 |
| Lemongrass Oil | | | 0.16 |
| Peppermint Oil | | 0.125 | |
| Rosemary Oil | | 0.125 | |
| TOTAL | 99.5 | 100.0 | 100.0 |

It was discovered that ethyl lactate has poor phase stability when used around 5-10% of the formulation, as seen in Formula 24.

It was further observed that Formulas 28-30 without isopropyl alcohol did not have phase separation issues even with butyl lactate present in the composition.

### Example 5

The following batches were made using a standard over-head mixer (Caframo Stirrer BDC3030), with the rpm set between 200-400 to provide sufficient agitation. Order of addition was mineral oil, isopropyl alcohol, isopropyl myristate, butyl lactate, triethyl citrate, then the essential oils.

All formulas had good stability at 25° C. (no phase separation) in PET bottles, all formulas had phase separation at −20° C., and only formula 32 had good stability (no phase separation) at 4° C. after 72 hours of storage.

TABLE 7

| | For- | For- | For- | For- | For- | For- |
|---|---|---|---|---|---|---|
| Component | mula 31 | mula 32 | mula 33 | mula 34 | mula 35 | mula 36 |
| White Mineral | 77.75 | 77.75 | 77.75 | 77.75 | 77.75 | 77.75 |
| Oil | | | | | | |
| Isopropyl | 17.50 | 17.50 | 17.50 | 17.50 | 17.50 | 17.50 |
| Alcohol | | | | | | |
| Isopropyl | | 4.25 | | | 2.13 | 2.13 |
| Myristate | | | | | | |
| n-Butyl Lactate | | | 4.25 | | 2.13 | |
| Triethyl Citrate | | | | 4.25 | | 2.13 |
| Total | 95.25 | 99.50 | 99.50 | 99.50 | 99.50 | 99.50 |

TABLE 8

| | For- | For- | For- | For- | For- |
|---|---|---|---|---|---|
| Component | mula 37 | mula 38 | mula 39 | mula 40 | mula 41 |
| White Mineral Oil | 77.75 | 77.75 | 77.75 | 77.75 | 77.75 |
| Isopropyl Alcohol | 17.50 | 17.50 | 17.50 | 17.50 | 17.50 |
| Isopropyl Myristate | | 1.42 | 2.83 | 0.71 | 0.71 |
| n-Butyl Lactate | 2.13 | 1.42 | 0.71 | 2.83 | 0.71 |
| Triethyl Citrate | 2.13 | 1.42 | 0.71 | 0.71 | 2.83 |
| Total | 99.50 | 99.50 | 99.50 | 99.50 | 99.50 |

TABLE 9
Inclusion Proportions for Design of Experiments (Formulas 32-41)

| Isopropyl Myristate | n-Butyl Lactate | Triethyl Citrate |
|---|---|---|
| 1 | 0 | 0 |
| 0 | 1 | 0 |
| 0 | 0 | 1 |
| 0.5 | 0.5 | 0 |
| 0.5 | 0 | 0.5 |
| 0 | 0.5 | 0.5 |
| 0.34 | 0.33 | 0.33 |
| 0.67 | 0.17 | 0.17 |
| 0.17 | 0.67 | 0.17 |
| 0.17 | 0.17 | 0.67 |

The present inventors have discovered unexpectedly that a formulation containing only essential oils, mineral oil, isopropyl alcohol at 10 wt. % or above, and isopropyl myristate was able to provide good phase stability at 4° C. and above. The removal of ethyl or butyl lactate and citrate from the mineral-oil based formulation containing isopropyl alcohol (Formula 32) added in the stability of isopropyl alcohol and prevents phase separation at 4° C. and above.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

All publications, patent applications, patents, and other references mentioned herein are incorporated by reference in their entirety. In case of conflict, the present specification, including definitions, will control. In addition, section headings, the materials, methods, and examples are illustrative only and not intended to be limiting.

What is claimed is:

1. An insecticidal composition comprising:
one or more essential oils and/or vegetable oils having insecticidal properties,
mineral oil in an amount of about 55 wt. % to about 95 wt. %, and
isopropyl alcohol in an amount of about 10 wt. % or higher,
wherein the insecticidal composition is substantially free of a lactate solvent, and
wherein the insecticidal composition shows no phase separation at about 4° C. after about 72 hours of storage.

2. The insecticidal composition of claim 1, wherein the one or more essential oils and/or vegetable oils is selected from the group consisting of cottonseed oil, clove oil, lemongrass oil, peppermint oil, cedarwood oil, rosemary oil, and geraniol.

3. The insecticidal composition of claim 1, wherein the insecticidal composition is substantially free of water.

4. The insecticidal composition of claim 1, further comprising at least one of the following: a preservative, a pH adjuster, a colorant, and a thickener.

5. The insecticidal composition of claim 1, further comprising isopropyl myristate.

6. The insecticidal composition of claim 5, wherein the isopropyl myristate is present in an amount of about 1 wt. % to about 10 wt. %.

7. The insecticidal composition of claim 1, further comprising one or more citric acid esters.

8. The insecticidal composition of claim 1, wherein the one or more citric acid esters is triethyl citrate.

9. The insecticidal composition of claim 1, wherein triethyl citrate is present in an amount of about 1 wt. % to about 5 wt. %.

10. An insecticidal composition comprising:
one or more essential oils and/or vegetable oils having insecticidal properties, and
a solvent consisting essentially of a mineral oil, isopropyl alcohol and isopropyl myristate,
wherein the insecticidal composition is stable at about 4° C. after about 72 hours of storage.

11. The insecticidal composition of claim 10, wherein the one or more essential oils and/or vegetable oils is selected from the group consisting of cottonseed oil, clove oil, lemongrass oil, peppermint oil, cedarwood oil, rosemary oil, and geraniol.

12. The insecticidal composition of claim 10, wherein the insecticidal composition is substantially free of water.

13. The insecticidal composition of claim 10, further comprising at least one of the following: a preservative, a pH adjuster, a colorant, and a thickener.

14. The insecticidal composition of claim 10, wherein the one or more essential oils and/or vegetable oils is present in an amount of about 0.1 wt. % to about 1 wt. %.

15. The insecticidal composition of claim 10, wherein the mineral oil is present in an amount of about 70 wt. % or more.

16. The insecticidal composition of claim 10, wherein isopropyl alcohol is present in an amount of about 10 wt. % to about 20 wt. %.

17. The insecticidal composition of claim 10, wherein isopropyl myristate is present in an amount of about 1 wt. % to about 10 wt. %.

18. An insect control product comprising:
the insecticidal composition of claim 1, and
a propellant.

19. A method for controlling insects, comprising the steps of:
providing an insecticidal composition comprising:
one or more essential oils and/or vegetable oils having insecticidal properties,
mineral oil, and
isopropyl alcohol,
wherein the insecticidal composition is substantially free of a lactate solvent,
diluting the insecticidal composition with water, and
applying the diluted insecticidal composition to the target surface.

20. The method of claim 19, wherein the insecticidal composition is continuously diluted with water via a garden hose.
